(19) United States
(12) Patent Application Publication
(10) Pub. No.: US 2026/0122482 A1
(43) Pub. Date: Apr. 30, 2026

(54) CONTACTLESS ONBOARDING OF EDGE ENDPOINT DEVICES THROUGH PROXY ENDPOINT

(71) Applicant: Dell Products L.P., Round Rock, TX (US)

(72) Inventors: MAHESH BABU RAMAIAH, Bangalore (IN); JOSEPH CAISSE, Burlington, MA (US); NAGARAJA BHASKAR NAIDU, Bengaluru (IN)

(21) Appl. No.: 18/930,349

(22) Filed: Oct. 29, 2024

(51) Int. Cl. H04L 9/32; H04L 9/08

(52) U.S. Cl. CPC H04L 9/3271; H04L 9/0825

(57) ABSTRACT

Methods and systems for managing endpoint devices are disclosed. The endpoint devices may be managed by automatically checking whether the endpoint devices are in condition for onboarding prior to performing onboarding procedures. If the endpoint devices are not in condition for onboarding, the endpoint devices may attempt to improve their condition by installing various pieces of software and obtaining contact information for other entities that participate in the onboarding procedures. Such information may be unable to the endpoint devices initially due to data loss or other events.

### FIELD

Embodiments disclosed herein relate generally to device management. More particularly, embodiments disclosed herein relate to systems and methods to facilitate device onboarding.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-1H show diagrams illustrating aspects of operation of the system of FIG. 1A in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a distributed system. To manage operation, endpoint devices may perform onboarding procedures to orchestrators. During the onboarding procedures, the endpoint devices may cryptographically verify authority over them using ownership vouchers.

Prior to onboarding, the endpoint devices may check their condition for onboarding. If unlikely to succeed, the endpoint devices may perform cooperative remedial activity to improve the likelihood of success. The remedial activity may include installing various pieces of software, updating configurations, obtaining contact information for other entities, and/or other activities that may improve the likelihood of successful onboarding.

By doing so, the endpoint devices may be more likely to successfully onboard and contribute to desired computer implemented services. Thus, embodiments disclosed herein may address, among others, the technical problem of lack of access to data required for onboarding. The technical problem may be addressed through cooperative action of already onboarded endpoint devices and not yet onboarded endpoint devices.

In an embodiment, a method for managing operation of an endpoint device is provided. The method may include, in response to the endpoint device powering on: making, by the endpoint device, a determination regarding whether the endpoint is in condition to onboard to any orchestrator; in a first instance of the determination where the endpoint device is not in the condition: broadcasting, by the endpoint device, a challenge to at least one other endpoint device managed by an orchestrator assigned to manage the endpoint device; obtaining, by the endpoint device, a mutual challenge that is responsive to the challenge; attempting, by the endpoint device, to verify the mutual challenge; in a first instance of the attempting where the mutual challenge is verified: obtaining, the endpoint device, update data from a remote data source using information from the mutual challenge; using, by the endpoint device, the update data to update operation of the endpoint device to obtain an updated endpoint device; and onboarding, by the updated endpoint device, to the orchestrator using a first copy of an ownership voucher.

The mutual challenge may be based on a public key from a second copy of the ownership voucher maintained by the orchestrator, the public key being part of a public-private keypair used by the endpoint device.

The mutual challenge may be attempted to be verified using a private key of the public-private keypair.

The endpoint device may not be in condition to onboard to any orchestrator due to an inability to communicate with a rendezvous server.

The endpoint device may lack the ability to communicate with a rendezvous server due to an operating system failure.

The endpoint device may lack the ability to communicate with the rendezvous server due to a change in network location of the rendezvous server after the endpoint device was programmed with a previous network location for the rendezvous server.

The update data may enable the endpoint device to correct the inability to communicate with the rendezvous server.

The updated data may include at least one selected from a list consisting of: a replacement operating system; and a network location of the rendezvous server.

The mutual challenge may include a payload, the payload may include the information, the information may include a network location for the remote data source.

Obtaining the update data may include modifying a boot order to boot to an operating system from the update data during a subsequent boot; and rebooting the endpoint device to perform the subsequent boot.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

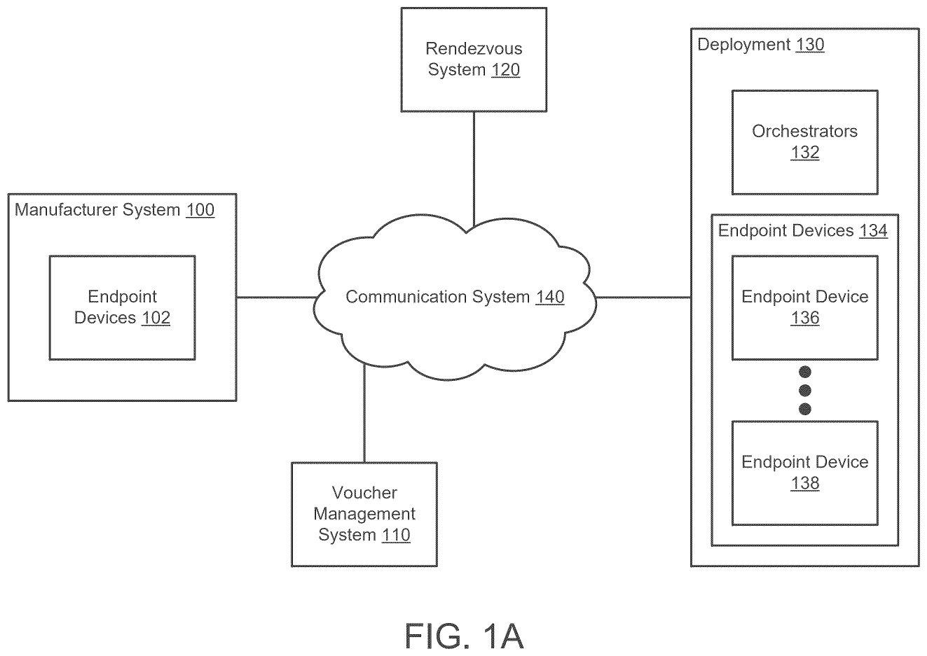

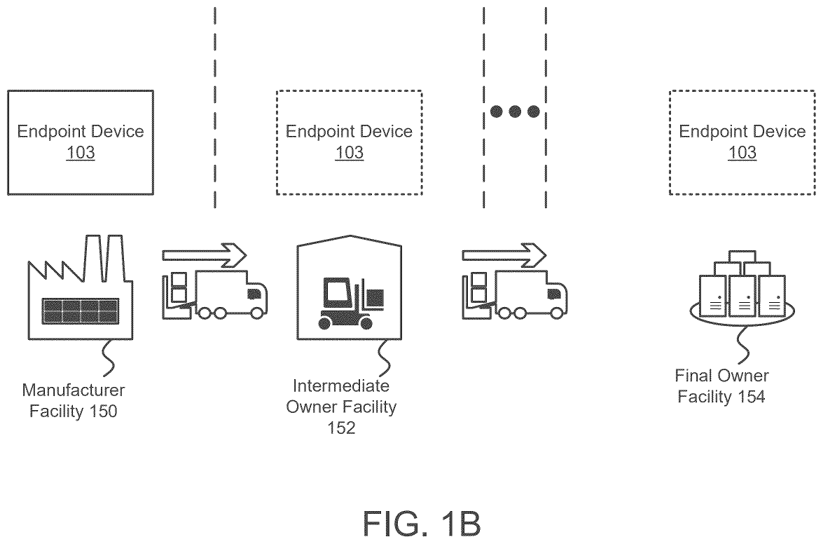

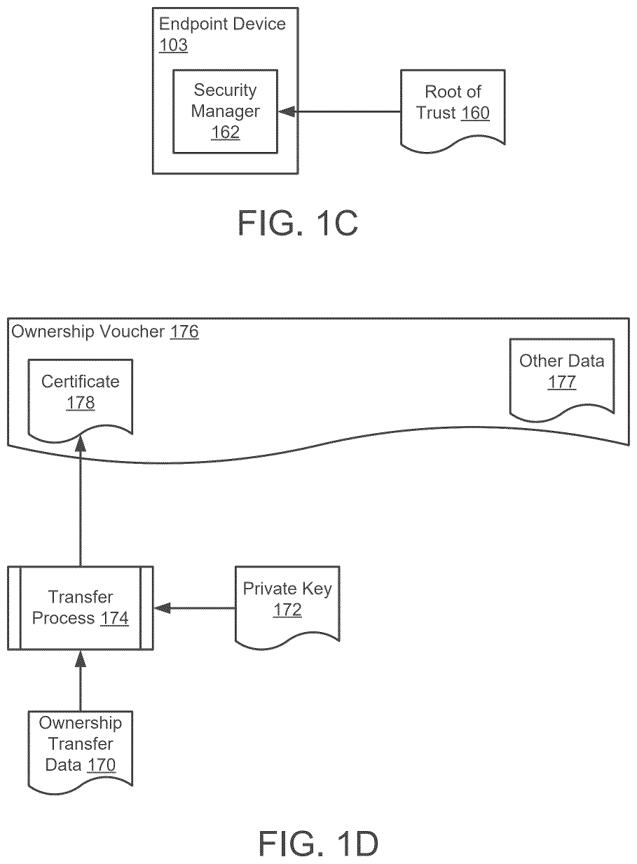

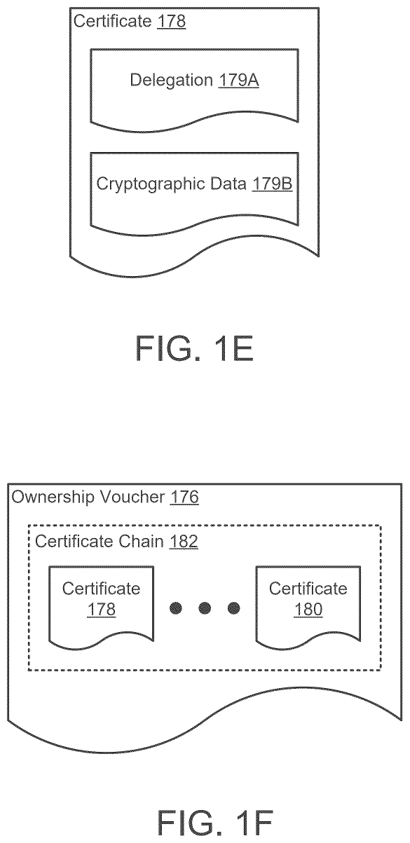

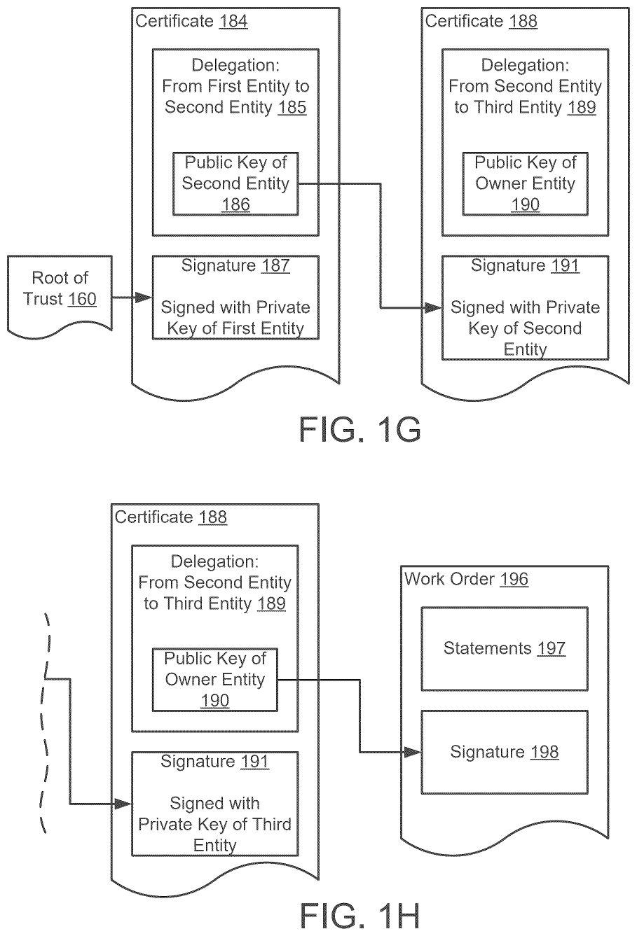

Turning to FIG. 1A, a block diagram illustrating a system in accordance with an embodiment is shown. The system shown in FIG. 1A may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, any number of endpoint devices may be deployed to a deployment. The endpoint devices may cooperatively provide the computer implemented services.

To manage the endpoint devices to provide the computer implemented services, authority over the endpoint devices may need to be established. In other words, the endpoint devices must be able to ascertain that they are under the authority of a particular entity. Based on this authority, the entity may, for example, issue work orders and/or other types of instructions to manage the operation of the endpoint devices to provide desired computer implemented services. After authority is established, the endpoint devices may be managed by the particular entity.

To facilitate ascertaining of the authority over them, the endpoint devices may utilize secrets. The secrets may allow the endpoint devices to cryptographically verify delegations of authority over the endpoint devices from a root of trust (e.g., a trusted key of a manufacturer) to another entity (e.g., an owner).

Overtime the resources requirements for providing computer implemented services may change and/or endpoint devices may need to be replaced. For example, additional services may be desired to be provided, different types of services may be desired to be provided, etc. In another example, an endpoint device that contributed to the computer implemented services may cease to operate thereby reducing the quantity of resources available to provide the computer implemented services. To satisfy the resource requirements based on these changes to an exist systems, additional endpoint devices may be onboarded and thereby contribute to the resources available to provide the computer implemented services.

To onboard an endpoint device, the endpoint device may need to operate in a predetermined manner. If unable to do so, then the endpoint device may not be able to complete onboarding processes. Consequently, the endpoint devices may be unable to provide desired computer implemented services.

In general, embodiments disclosed herein may provide methods, systems, and/or devices for improving the likelihood of successfully onboarding endpoint devices. To improve the likelihood the endpoint devices may perform self check procedures prior to performing onboarding. The self check procedures may enable the endpoint devices to identify whether they are likely to operate in the predetermined manner, or other manners.

If any of the endpoint devices are unlikely to operate in the predetermined manner during onboarding, then the endpoint devices may perform remedial activity. The remedial activity may include, for example, validating that a not yet onboarded device is to be onboarded to an orchestrator, facilitating communications and verifications between the not yet onboarded device and the orchestrator, and obtaining software and/or other information usable by the not yet onboarded endpoint device to perform the onboarding.

By doing so, embodiments disclosed herein may improve the likelihood of desired computer implemented services being provided. Consequently, a system in accordance with an embodiment disclosed herein may have higher uptime, be of higher performance (e.g., by virtue of successful integration of endpoint devices), and/or may otherwise be more likely to provide desired computer implemented services.

To provide the above noted functionality, the system of FIG. 1A may include manufacturer system 100, voucher management system 110, rendezvous system 120, deployment 130, and communication system 140. Each of these components is discussed below.

Manufacturer system 100 may be a system used by a manufacturer of endpoint devices 102. Manufacturer system 100 may include, for example, factories, assembly plants, distribution facilities, and/or other types of facilities for creating endpoint devices 102. Endpoint devices 102 may be data processing systems which may be usable to provide various computer implemented services.

When manufactured, manufacturer system 100 may put endpoint devices 102 in condition for subsequent onboarding to various deployments (e.g., 130) and/or other environments (e.g., data centers, edge systems, etc.) in which endpoint devices may be positioned to provide desired computer implemented services.

To place endpoint device 102 in condition for subsequent onboarding, manufacturer system 100 may (i) establish a root of trust for each endpoint device, (ii) record various information regarding the endpoint devices (e.g., hardware/software loadout, identifiers of various components positioned therein, etc.), and (iii) install various pieces of software (e.g., operating systems, applications, etc. to be used prior to onboarding and/or reconfiguration by orchestrators 132), establish various configuration settings (e.g., such as contact information for rendezvous system 120), update various hardware components, and/or perform other actions so that only entities to which authority over the endpoint devices has been delegated from the root of trust are able to control and/or otherwise use the endpoint device. Refer to FIG. 1C for additional details regarding establishing a root of trust for the endpoint device.

Once constructed, endpoint devices 102 may be sold directly to end users and/or placed into the stream of commerce (e.g., sold to resellers, etc.) and through which endpoint devices 102 eventually reach end users. The intermediate owners may make modifications to the hardware and/or software of the endpoint devices. Refer to FIG. 1B for additional details regarding how endpoint devices may reach end users (e.g., individuals, organizations, etc.).

As ownership over the endpoint devices changes, information regarding the changes in ownership and/or authority may be recorded in an ownership voucher. The ownership voucher may allow an end user to establish authority over the endpoint device such that the endpoint device will be usable by the end user. The ownership voucher may also include device keys (e.g., public keys corresponding to private keys used by the endpoint devices), identifiers (e.g., globally unique identifiers), and/or other information.

Voucher management system 110 may document and manage information regarding changes in ownership and authority over endpoint devices 102. To do so, voucher management system 110 may generate ownership vouchers. An ownership voucher may be a cryptographically verifiable data structure usable to establish which entities have authority over endpoint devices 102.

For example, an ownership voucher may include certificate chains that documents the changes in ownership and authority over endpoint devices 102. Each certificate may be signed using various keys. The keys used to sign (e.g., private keys) and keys included in (e.g., public keys) in ownership vouchers may enable endpoint devices to ascertain whether to trust various data structures, such as work orders which may be signed. Refer to FIGS. 1D-1H for additional information regarding ownership vouchers.

When one of endpoint devices 102 is obtained by an end user, the end user may add the endpoint devices to a collection such as deployment 130. When so added, an orchestrator (e.g., one of orchestrators 132) or other entity may utilize a corresponding ownership voucher from voucher management system 110 to establish authority over the endpoint device. In this manner, any number of endpoint devices (e.g., 134) may be onboarded and brought under the control of a control plane which may include any number of orchestrators (e.g., 132). Different endpoint devices (e.g., 136, 138) may be onboarded at different points in time and/or for different purposes.

When one of endpoint devices 102 initially powers on after manufacturing and prior to onboarding, the endpoint device may reach out to rendezvous system 120. Rendezvous system 120 may be a system that directs endpoint devices to entities such as orchestrators 132 that will onboard the endpoint devices.

To do so, the entities such as orchestrators 132 may provide rendezvous system 120 with information usable to authenticate that orchestrators 132 will manage the endpoint devices. For example, orchestrators 132 may provide information from ownership and/or other sources to rendezvous system 120. Once verified, rendezvous system 120 may redirect endpoint devices to the corresponding entities when the endpoint devices reach out to rendezvous system 120 after being powered on.

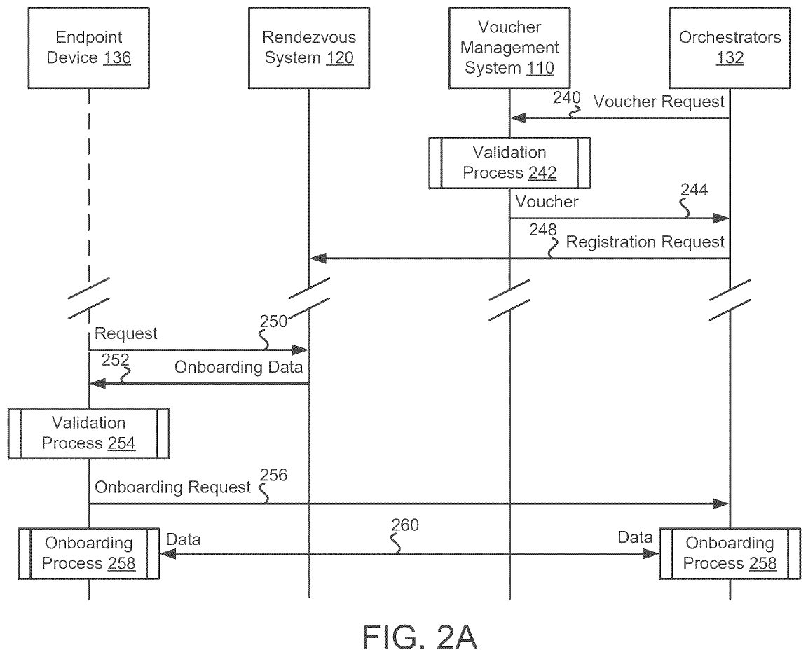

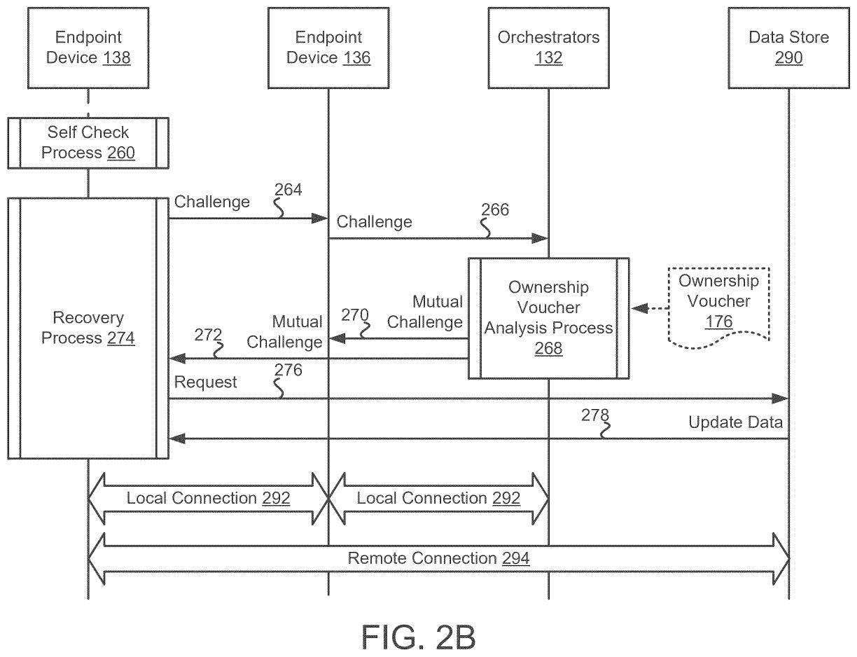

Once directed to one of orchestrators 132, new endpoint devices (e.g., 102) may obtain and/or verify ownership vouchers that allege to indicate that authority over them has been delegated to orchestrators 132 (and/or an owner/operator of orchestrators 132). During the verification, integrity of the ownership vouchers may be cryptographically verified, and the content (and/or other information) may be checked to ascertain whether orchestrators 132 has been delegated authority over the new endpoint devices. Refer to FIGS. 2A-2B for additional information regarding onboarding and ownership voucher verification.

If successfully verified as being trustworthy, then the endpoint device (and a corresponding orchestrator, which may perform similar procedures to verify copies of the ownership voucher prior to participating in onboarding) and orchestrator may proceed to complete the onboarding. During the onboarding, endpoint devices 134 may perform various operations to complete onboarding. The operations may include any number and type of operation (e.g., configuration operations, security operations, software installation operations, account establishment operations, etc.), and the operations may be directed by orchestrators 132. Once onboarded, the endpoint devices may begin to contribute to computer implemented services provided by deployment 130.

However, to participate in onboarding after powering up, the endpoint devices may need (i) to be in an operable state such as hosting working operating systems, applications, etc., and (ii) may need information usable to communicate with rendezvous system 120. If any of the aforementioned information is unavailable, then the endpoint devices may be unable to perform onboarding.

To address such scenarios, endpoint devices may perform remedial activity prior to onboarding. The remedial activity may enable the endpoint devices to obtain replacement software and/or obtain lost or missing but necessary information for onboarding.

When providing their functionality, any of manufacturer system 100, endpoint devices 102, voucher management system 110, rendezvous system 120, deployment 130, orchestrators 132, and/or endpoint devices 134 may perform all, or a portion, of the processes, interactions, and methods illustrated in FIGS. 1B-3.

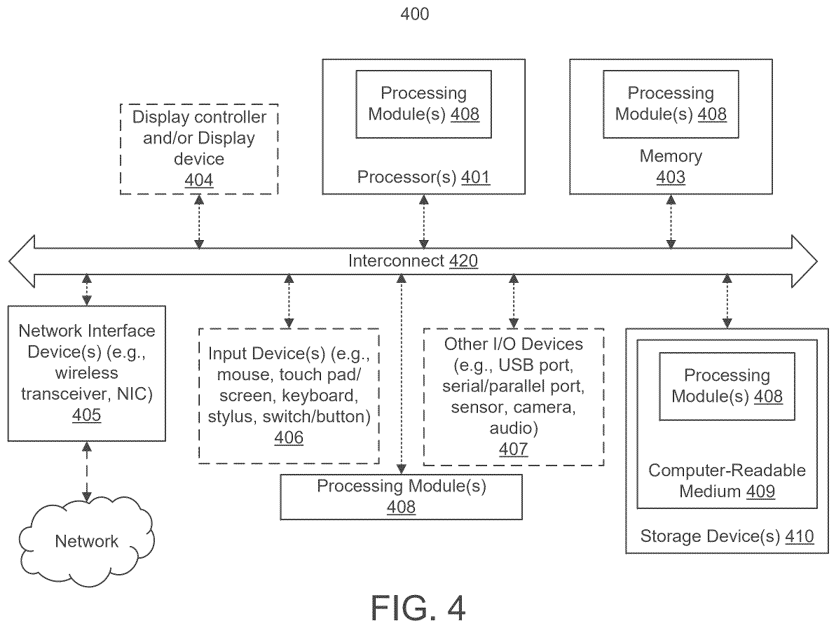

Any of manufacturer system 100, endpoint devices 102, voucher management system 110, rendezvous system 120, deployment 130, orchestrators 132, and endpoint devices 134 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with communication system 140. Communication system 140 may facilitate communications between the components of FIG. 1A. In an embodiment, communication system 140 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

As discussed above, endpoint devices (e.g., 102) may traverse through a stream of commerce between when the endpoint devices are manufactured and when the endpoint devices reaches a final owner. Turning to FIG. 1B, a diagram of an example path through a stream of commerce in accordance with an embodiment is shown.

In FIG. 1B, vertical dashed lines indicate different geographic locations in which various facilities may be positioned. Representations of such facilities (e.g., 150-154) may be positioned below the pages. Representations of movement of endpoint devices between these facilities is illustrated using truck shaped images. Some instances of the graphical representation of endpoint device 103 are illustrated using dashed outlining to indicate that endpoint device 103 may only be present at one of the facilities at any point in time, and the instance of the graphical representation of endpoint device 103 drawn in solid outlining indicates where endpoint device 103 is located in the example shown in FIG. 1B.

The stream of commerce may begin, for example, at manufacturer facility 150. Manufacturer facility 150 may be a facility operated by a manufacturer of endpoint devices. During manufacturing, the manufacturer may establish a root of trust for an endpoint device (e.g., 103), install various software, add hardware components, store information such as contact information for rendezvous systems, install and/or cause public-private key pairs (or portions thereof) to be generated and used (e.g., such as device keys), etc. Refer to FIG. 1C for additional details regarding establishing the root of trust for endpoint device 103. The root of trust may be used by endpoint device 103 to discern which entities have authority over it, which entities to trust, and/or for other purposes. The initial root of trust may indicate that the manufacturer is the owner of and has authority over endpoint device 103.

Once the root of trust is established, endpoint device 103 may be sold and resold to various intermediate owners. These intermediate owners may operate various intermediate owner facilities (e.g., 152), such as warehouses, distribution centers, sales rooms, etc. When sold, endpoint device 103 may be shipped to these various facilities. While at these facilities, various software and/or hardware component modifications may be made. Accordingly, the state of endpoint devices 103 may change.

Finally, once purchased from an intermediate owner, a final owner may operate a final owner facility (e.g., 154), such as a data center, edge deployment, and/or other type of computer deployment to which endpoint device 103 may be onboarded. To facilitate onboarding, voucher management system 110 may collect and add information regarding changes in ownership of endpoint device 103 to an ownership voucher. Orchestrators 132 may use the ownership voucher to establish authority over endpoint device 103.

Turning to FIG. 1C, a diagram of an example process for establishing a root of trust in endpoint device 103 in accordance with an embodiment is shown. To establish a root of trust, when endpoint device 103 is manufactured, root of trust 160 may be installed in endpoint device 103.

Root of trust 160 may be a public key of a public private key pair controlled by the manufacturer of endpoint device 103. The public private key pair may be established using any process.

To install root of trust 160, root of trust 160 may be stored in endpoint device 103. The storage location and security precautions taken with respect to storing root of trust 160 may vary depending on the architecture of endpoint device 103.

For example, endpoint device 103 may host or include a security manager (e.g., 162). Security manager 162 may be implemented using a discrete hardware component (e.g., a trusted platform module), or may be a software component. Security manager 162 may enforce various security policies on endpoint device 103. For example, the security policies may require that endpoint device 103 validate authority over it back to root of trust 160 before complying with any instructions from other entities that allege to have authority over endpoint device 103.

To validate entities having authority over endpoint device 103, endpoint device 103 may utilize ownership vouchers.

Turning to FIG. 1D, a diagram of an example process for generating ownership voucher 176 in accordance with an embodiment is shown. To generate ownership voucher 176, information regarding changes in ownership and authority over an endpoint device may be added. The information may take the form of a cryptographically verifiable certificate (e.g., 178). Refer to FIG. 1E for additional information regarding certificate 178.

To add a certificate to ownership voucher 176, transfer process 174 may be performed. During transfer process 174, ownership transfer data 170 and private key 172 may be obtained. Ownership transfer data 170 may document a change in ownership and/or authority over an endpoint device. For example, when an endpoint device is sold, a public key of a public private key pair controlled by the purchaser may be added to ownership transfer data 170, along with other types of information regarding the transfer. This public key may be usable to verify signed work orders or other signed data structures from the new owner (e.g., the new owner may be able to use the corresponding private key for signing). The information in ownership transfer data 170 may be treated as a delegation statement, which an endpoint device may parse to identify entities having authority over it.

Private key 172 may be a private key of a public private key pair controlled by an entity that has authority over an endpoint device at the time authority over the endpoint device changes (e.g., via sale or other mechanism). In a scenario in which the manufacturer is the seller, the private key corresponding to the root of trust may be private key 172. Similarly, in a scenario in which an intermediate owner is the seller, private key 172 may be the private corresponding to the public key included in the delegation statement in ownership voucher 176 that establishes the intermediate owner has the owner of the endpoint device. In other words, to establish a delegation of authority, the entity that has authority over the endpoint device as defined by the certificates of ownership voucher 176 may need to sign the ownership transfer data 170 to further delegate ownership and authority over the endpoint device. By doing so, a chain of delegations that are cryptographically verifiable back to the root of trust may be established. Refer to FIGS. 1F-1H for additional details regarding establishing chains of delegations.

Any number of certificates may be added to ownership voucher 176 thereby enabling certificate chains that establish chains of delegation from the root of trust for an endpoint device. Ownership voucher 176 may, as discussed above, be used during onboarding.

In addition to certificates, ownership voucher 176 may include other data 177. Other data 177 may include, for example, (i) public keys corresponding to private keys maintained and used by an endpoint device, (ii) identification information for the endpoint devices, and/or other information usable to onboard to an orchestrator and/or manage operation of the endpoint device. Other data 177 may be obtained during manufacturing and provided to a voucher management system.

Turning to FIG. 1E, a diagram of an example certificate 178 in accordance with an embodiment is shown. Certificate 178 may include delegation 179A and cryptographic data 179B.

Delegation 179A may include information documenting a delegation of authority/ownership over an endpoint device. For example, delegation 179A may include a public key, and indicate what is delegated to the entity that has control over the public private key pair of which the public key is a member. The extent of what is delegated may be specified at a macro level (e.g., ownership) or a micro level (e.g., limited authority).

Cryptographic data 179B may include a signature usable to verify the integrity of delegation 179A and ascertain whether delegation 179A is valid.

To determine whether certificate 178 includes a valid delegation, an endpoint device may attempt to establish a chain of delegations back to the root of trust.

Turning to FIG. 1F, a diagram of an example certificate chain 182 of ownership voucher 176 in accordance with an embodiment is shown. Certificate chain 182 may include a series of certificates that can be sequentially validated back to the root of trust. To sequentially validate the certificate back to the root of trust, the first certificate (e.g., 178) in the chain may attempt to be validated using the root of trust (e.g., a public key). Thus, the first certificate in the chain may only be validated if the private key (e.g., controlled by the manufacturer) corresponding to the root of trust was used to sign certificate 178. Other certificates in the chain may be similarly validated by using the public key from the delegation statement of the previous certificate to check the signature in the next certificate in the chain. Certificate chain 182 may include any number of certificates (e.g., 178-180) that can be sequentially verified back to the root of trust. Refer to FIGS. 1G-1H for additional information regarding establishing valid certificate chains.

Turning to FIG. 1G, a diagram of an example process for validating a portion of a certificate chain of an ownership voucher in accordance with an embodiment is shown. In FIG. 1G, two certificates (e.g., 184, 188) from a certificate chain are shown.

As seen, certificate 184 may include delegation 185 which includes a public key (e.g., 186) of a second entity. The delegation statement may indicate that a first entity is delegating authority to the second entity.

Certificate 184 may include signature 187. Signature 187 may be generated using a private key controlled by the first entity that delegated authority to the second entity. In this example, the private key may correspond to root of trust 160 (e.g., may be a private corresponding to the public key installed when an endpoint device is manufactured).

To establish a certificate chain, signature 187 may be checked using root of trust 160. If verified as having been signed using the private key corresponding to the root of trust, then certificate 184 may be treated as being valid.

Like certificate 184, certificate 188 may include delegation 189 which includes a public key (e.g., 190) of a third entity, and in this example the owner. The delegation statement of delegation 189 may indicate that the second entity is delegating authority to the third entity (i.e., the owner).

Certificate 188 may include signature 191. Signature 91 may be generated using a private key controlled by the second entity that delegated authority to the third entity. In this example, the private key may correspond to the public key (e.g., 186) of the second entity which may be included in delegation 185. To extend the certificate chain, signature 191 may be checked using a public key

managed by second entity 186. If verified as having been signed using the private key corresponding to public key managed by second entity 186, then certificate 188 may be treated as being valid.

Once the chain is established, the delegations (e.g., 185, 189) in the chain may be parsed to identify keys (e.g., a public key) to which authority has been delegated from root of trust 160. The public key may then be used to decide whether various work orders are valid, which entities have authority of an endpoint device, and/or for other purposes.

For example, during onboarding, an endpoint device may evaluate whether to perform various work orders using the keys to which authority has been delegated.

Turning to FIG. 1H, a diagram of an example process for validating a work order in accordance with an embodiment is shown. In FIG. 1H, only a portion of the certificates (e.g., 184, 188) shown in FIG. 1G are shown for clarity.

When a work order (e.g., 196) is received by an endpoint device, the endpoint device may evaluate whether the entity issuing the work order has authority over the endpoint device. To do so, the endpoint device may parse the certificates (of an ownership voucher that has been verified to be trustworthy using the distributed immutable ledger) to identify the public keys to which authority over the endpoint device has been delegated.

The endpoint device may then, using the keys, check a signature (e.g., 198) included in the work order. If the signature can be verified as having been generated using the private key corresponding to one of the public keys to which authority over the endpoint device has been delegated, then the endpoint device may treat work order 196 as having been issued by an entity with authority over it. For example, signature 198 may be checked using a public key managed by owner entity 190, in this example.

The endpoint device may then, for example, process various statements 197 included in work order 196, and take action based on those statements. These statements may include instructions that change the manner of operation of the endpoint device to, for example, comply with security requirements of a new owner, and/or perform other actions.

To further clarify embodiments disclosed herein, interactions diagrams in accordance with an embodiment are shown in FIGS. 2A-2B. These interactions diagrams may illustrate how data may be obtained and used within the system of FIGS. 1A-1H.

In the interaction diagrams, processes performed by and interactions between components of a system in accordance with an embodiment are shown. In the diagrams, components of the system are illustrated using a first set of shapes (e.g., 110, 120, 132, 136, etc.), located towards the top of each figure. Lines descend from these shapes. Some descending lines are drawn in dashing to indicate that the device is not operating during corresponding periods of time, while other lines are drawn solid to indicate that the devices are operating during the corresponding period of time. For example, in FIG. 2A, endpoint device 136 may not be operating until interaction 250.

Processes performed by the components of the system are illustrated using a second set of shapes (e.g., 242, 254, etc.) superimposed over these lines. Interactions (e.g., communication, data transmissions, etc.) between the components of the system are illustrated using a third set of shapes (e.g., 240, 244, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 240 may occur prior to the interaction labeled as 244. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during onboarding of an endpoint device.

To onboard endpoint device 136, orchestrators 132 may, at interaction 240, send a voucher request to voucher management system 110. The voucher request may be a request for an ownership voucher for an endpoint device (e.g., 136). In the example interactions shown in FIG. 2A, an entity may have purchased endpoint device 136 thereby causing voucher management system 110 to add information to the ownership voucher for endpoint device 136 that establishes chains of certificates/delegations from the root of trust to the owner.

When received, voucher management system 110 may attempt to validate the voucher request by performing validation process 242. During validation process, credentials and/or other information from orchestrators 132 may be evaluated to ascertain whether an ownership voucher should be provided. Presuming that the validation process is successful, at interaction 244, voucher management system 110 may send an ownership voucher to orchestrators 132.

Once obtained, at interaction 248, orchestrators 132 may send a registration request to rendezvous system 120. The registration request may be a request to have rendezvous system 120 redirect endpoint device 136 to orchestrators 132. The registration request may include information usable by rendezvous system 120 to verify that orchestrators 132 should have authority over endpoint device 136 (e.g., may be portions of the ownership voucher, or entire ownership voucher).

Once endpoint device 136 reaches a destination location (e.g., a data center, edge deployment, etc.), endpoint device 136 may be powered on and may ascertain whether it is in condition for onboarding. In other words, endpoint device 136 may perform a self check. If the self check is passed, then the interactions shown in FIG. 2A may continue as shown. However, if the self check is unsuccessful, then remedial activity may be performed. Refer to FIG. 2B for additional information regarding remedial activity that may be performed when self checks by endpoint devices prior to onboarding fail.

Returning to the discussion of FIG. 2A, presuming the rendezvous system 120 registered orchestrators 132 based on the registration request, rendezvous system may, at interaction 252, provide onboarding data to endpoint device 136 after endpoint device 136, at interaction 250, sends a request for it. The onboarding data may include, for example, various validation information and re-direct information (e.g., network address) for orchestrators 132. Because orchestrators 132 may operate as part of a federated orchestrator system, it will be appreciated that orchestrators 132 may not necessarily pair endpoint device 136 with the same orchestrator over time (e.g., as endpoint device 136 powers on and/or otherwise reconnects to orchestrators 132 over time).

Once obtained, endpoint device 136 may perform validation process 254. During validation process 254, endpoint device 136 may attempt to validate the onboarding data. If successfully validated, endpoint device 136 may, at interaction 256, generate and send an onboarding request to orchestrators 132. The onboarding request may request, for example, cryptographic data such as ownership vouchers.

Sending of the onboarding request may initiate performance of onboarding process 258. During the onboarding process, orchestrators 132 and/or endpoint device 136 may attempt to validate a corresponding ownership voucher.

Presuming that the ownership voucher is successfully verified, endpoint device 136 may attempt to ascertain whether orchestrators 132 (or, more specifically, one of orchestrators 132 that is assigned to onboard endpoint device 13) has authority over endpoint device 136. To do so, endpoint device 136 may, as discussed above, attempt to validate certificate chains and delegation statements of the ownership voucher to establish a chain of delegation of authority from the root of trust to the one of orchestrators 132 (e.g., the delegation statements may identify a particular public key for which orchestrators 132 control a corresponding private key). Endpoint device 136 may issue various challenges (e.g., signing challenges) to the one of orchestrators 132, and endpoint device 136 may test the signed responses to the challenges using the particular public key. If the signed responses can be validated using the public key, then endpoint device 136 may conclude that at least the one of orchestrators 132 has authority over it.

If successfully validated as having authority over it, endpoint device 136 may continue to participate in the onboarding by, for example, evaluating the trustworthiness of signed work orders issued by orchestrators 132, complying with any signed work orders that can be validated as having been signed with the private key corresponding to the particular public key, establishing keys or other cryptographic data used to secure communications between endpoint device 136 and the one of orchestrators 132, and/or performing other actions. Thus, once onboarding process 258 is complete, endpoint device 136 may have credentials (e.g., keys, other cryptographic data usable with various protocols such as transport layer security (TLS) protocols) usable to communicate with orchestrators 132.

Turning to FIG. 2B, a second interaction diagram in accordance with an embodiment is shown. The second interaction diagram may illustrate processes and interactions that may occur when endpoint device 136 powers on.

After powering on, endpoint device 138 may perform self check process 260 (e.g., presuming that endpoint device 138 has not been onboarded). During self check process 260, endpoint device 138 may evaluate whether it is in condition to onboard to an orchestrator. To onboard to an orchestrator, endpoint device 138 may need to operate in a predetermined manner (e.g., by hosting certain software, configurations, etc.) and have information usable to reach rendezvous system 120, as discussed above. However, corruption of software/data, and/or stale contact information (e.g., may change over time) for rendezvous system 120 may prevent endpoint device 136 from being in condition to onboard.

In this example, presume that endpoint device 138 fails the self check and concludes that it is not in condition for onboarding. Based on the conclusion, recovery process 274 may be performed. During recovery process 274, endpoint device 183 may cooperatively obtain information usable to place endpoint device 138 in condition to onboard.

During recovery process 274, endpoint device 138 may generate and send a challenge at interaction 264. The challenge may be broadcast over a local ethernet network. Thus, it is likely that other endpoint devices (e.g., endpoint device 136, which previously successfully onboarded) may receive the broadcast challenge.

The challenge may include information regarding endpoint device 138 usable to identify it, a signature using a private key maintained by endpoint device 138, information indicating that endpoint device 138 is in need of assistance, a hash or other cryptographic data related to the information in the payload, and/or other information. Once broadcast, endpoint device 136 (e.g., operably connected via local connection 292) may receive the challenge and, at interaction 266, forward the challenge to orchestrators 132. Already onboarded endpoint devices (e.g., 136) may look for such challenges in network communications during their regular operation, and forward them accordingly.

Once the challenge is obtained by orchestrators 132 (e.g., via local connection 292, which may also be an ethernet link or other type of layer 2 communication that is not routable), orchestrators 132 may perform ownership voucher analysis process 268. During ownership voucher analysis process 268, existing ownership vouchers (e.g., 176) obtained by orchestrators 132 may be analyzed to identify device public keys contained therein. The device public keys may be used to attempt to verify the challenge (e.g., by signature checking, or decryption if the payload is encrypted using the device private key of endpoint device 138). If a device public key is found that is usable to verify the challenge, then orchestrators 132 may conclude that endpoint device 138 is assigned to it for management, and needs assistance.

To assist endpoint device 138, orchestrators 132 may generate and broadcast a mutual challenge at interactions 270 and 272. Mutual challenge may include a payload with information usable to reach data store 290, and may be encrypted using the device public key.

When so broadcast, each of endpoint device 136 and endpoint device 138 may receive a copy of the mutual challenge. Each endpoint device may attempt to verify the mutual challenge using their corresponding device private key. In this example, endpoint device 138 is able to verify the mutual challenge, and consequently trusts and uses the payload.

For example, endpoint device 138 may, at interaction 276, send a request to data store 290 using the contact information from the mutual challenge. The request may be for data (e.g., program files, configurations, contact information for the rendezvous system, etc.) usable by endpoint device 138 to place it in condition for onboarding.

Responsive to the request, at interaction 278, data store 290 may provide the requested data. Once obtained, endpoint device 138 may use the requested data to update its operation and proceed to onboard to orchestrators 132 (e.g., may return to interaction 250 shown in FIG. 2A).

Thus, using the interactions shown in FIG. 2B, an endpoint device may correct itself to be in condition for onboarding. Consequently, the endpoint device may be tolerant to data corruption and/or other types of information loss for onboarding purposes.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, databases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

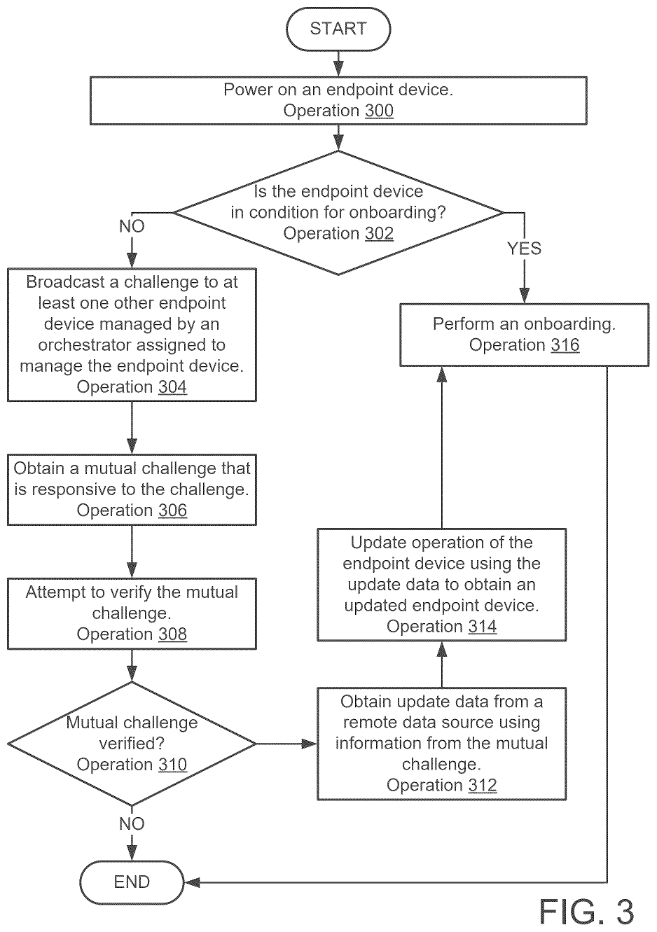

As discussed above, the components of FIG. 1A may perform various methods to manage endpoint devices. FIG. 3 illustrates a method that may be performed by the components of the system of FIGS. 1A-1H. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of endpoint devices in accordance with an embodiment is shown. The method may be performed by any of the components of the system shown in FIG. 1A.

Prior to operation 300, an endpoint device may be manufactured, and sold to an end user such as an organization. The organization may maintain a orchestrators (e.g., independent computing devices) to manage endpoint devices owned by the organization.

At operation 300, an endpoint device is powered on. For example, when positioned in a data center, a rack, or other computing environment power may be provided to the endpoint device. The endpoint device may power on in response to the provided power.

At operation 302, a determination is made regarding the endpoint device is in condition for onboarding. The determination may be made by identifying whether the endpoint device has access to predetermined software, configurations, and contact information for a rendezvous system. If the endpoint device does not have access to the aforementioned information, then the endpoint device may conclude that it is not in condition for onboarding.

If the endpoint device is in condition for onboarding, then the method may proceed to operation 316. Otherwise, the method may proceed to operation 304.

At operation 304, the endpoint device may broadcast a challenge to at least one other endpoint device managed by an orchestrator assigned to manage the endpoint device. The challenge may be broadcast by (i) generating the challenge using a device private key, and (ii) transmitting it to other devices via layer two of a network (e.g., an ethernet network) that interconnects the endpoint devices and/or orchestrators.

At operation 306, a mutual challenge from the other endpoint device may be obtained that is responsive to the challenge. The mutual challenge may be obtained by receiving it via a network communication. The mutual challenge may be generated by the orchestrator and which may broadcast it. The mutual challenge may include information for contacting a data source that includes replacement information for the information identified in operation 300 as missing. The challenge may be cryptographically verifiable.

At operation 308, an attempt is made to verify the mutual challenge. The attempt may be made using a device private key maintained by the endpoint device.

At operation 310, it is determined whether the mutual challenge is verified in operation 308. If verified, then the method may proceed to operation 312. If not verified, then the method may end following operation 310. Ending may terminate the endpoint device's attempt to onboard to the orchestrator for lack of access to necessary information.

At operation 312, update data from a remote data source is obtained using information from the mutual challenge. The update data may be obtained by requesting it, and receiving a copy of it from the data source.

At operation 314, operation of the endpoint device is updated using the update data to obtain an updated endpoint device. For example, software may be installed, configurations may be obtained, contact information for a rendezvous system may be updated, etc. The updated endpoint device may be in condition for onboarding.

At operation 316, an onboarding is performed. The onboarding may be similar to that discussed with respect to FIG. 2A. For example, the endpoint device may contact a rendezvous system, redirect to an orchestrator, use a copy of an ownership voucher to verify authority of the orchestrator, and cooperate with the orchestrator once its authority is verified.

The method may end following operation 316.

Thus, using the method shown in FIG. 3, embodiments disclosed herein may improve the likelihood of endpoint devices being able to provide computer implemented services by improving the likelihood of endpoint devices being able to be in condition for onboarding.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 420. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 420 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 410 may include computer-readable storage medium 409 (also known as a machine-readable storage medium or a computer-readable medium) on which is stored one or more sets of instructions or software (e.g., processing module, unit, and/or processing module/unit/logic 408) embodying any one or more of the methodologies or functions described herein. Processing module/unit/logic 408 may represent any of the components described above. Processing module/unit/logic 408 may also reside, completely or at least partially, within memory 403 and/or within processor 401 during execution thereof by system 400, memory 403 and processor 401 also constituting machine-accessible storage media. Processing module/unit/logic 408 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 408, components and other features described herein can be implemented as discrete hardware components or integrated in the functionality of hardware components such as ASICS, FPGAs, DSPs or similar devices. In addition, processing module/unit/logic 408 can be implemented as firmware or functional circuitry within hardware devices. Further, processing module/unit/logic 408 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of an endpoint device, the method comprising:
in response to the endpoint device powering on:
making, by the endpoint device, a determination regarding whether the endpoint is in condition to onboard to any orchestrator;
in a first instance of the determination where the endpoint device is not in the condition:
broadcasting, by the endpoint device, a challenge to at least one other endpoint device managed by an orchestrator assigned to manage the endpoint device;
obtaining, by the endpoint device, a mutual challenge that is responsive to the challenge;
attempting, by the endpoint device, to verify the mutual challenge;
in a first instance of the attempting where the mutual challenge is verified:
obtaining, the endpoint device, update data from a remote data source using information from the mutual challenge;
using, by the endpoint device, the update data to update operation of the endpoint device to obtain an updated endpoint device; and
onboarding, by the updated endpoint device, to the orchestrator using a first copy of an ownership voucher.

2. The method of claim 1, wherein the mutual challenge is based on a public key from a second copy of the ownership voucher maintained by the orchestrator, the public key being part of a public-private keypair used by the endpoint device.

3. The method of claim 2, wherein the mutual challenge is attempted to be verified using a private key of the public-private keypair.

4. The method of claim 1, wherein the endpoint device is not in condition to onboard to any orchestrator due to an inability to communicate with a rendezvous server.

5. The method of claim 4, wherein the endpoint device lacks the ability to communicate with a rendezvous server due to an operating system failure.

6. The method of claim 4, wherein the endpoint device lacks the ability to communicate with the rendezvous server due to a change in network location of the rendezvous server after the endpoint device was programmed with a previous network location for the rendezvous server.

7. The method of claim 4, wherein the update data enables the endpoint device to correct the inability to communicate with the rendezvous server.

8. The method of claim 7, wherein the updated data comprises at least one selected from a list consisting of:
a replacement operating system; and
a network location of the rendezvous server.

9. The method of claim 1, wherein the mutual challenge comprises a payload, the payload comprising the information, the information comprising a network location for the remote data source.

10. The method of claim 1, wherein obtaining the update data comprises:
modifying a boot order to boot to an operating system from the update data during a subsequent boot; and
rebooting the endpoint device to perform the subsequent boot.

11. A non-transitory machine-readable medium having instructions stored therein, which when executed by a processor, cause the processor to perform operations for managing an endpoint device, the operations comprising:
in response to the endpoint device powering on:
making, by the endpoint device, a determination regarding whether the endpoint is in condition to onboard to any orchestrator;
in a first instance of the determination where the endpoint device is not in the condition:
broadcasting, by the endpoint device, a challenge to at least one other endpoint device managed by an orchestrator assigned to manage the endpoint device;
obtaining, by the endpoint device, a mutual challenge that is responsive to the challenge;
attempting, by the endpoint device, to verify the mutual challenge;
in a first instance of the attempting where the mutual challenge is verified:
obtaining, the endpoint device, update data from a remote data source using information from the mutual challenge;
using, by the endpoint device, the update data to update operation of the endpoint device to obtain an updated endpoint device; and
onboarding, by the updated endpoint device, to the orchestrator using a first copy of an ownership voucher.

12. The non-transitory machine-readable medium of claim 11, wherein the mutual challenge is based on a public key from a second copy of the ownership voucher maintained by the orchestrator, the public key being part of a public-private keypair used by the endpoint device.

13. The non-transitory machine-readable medium of claim 12, wherein the mutual challenge is attempted to be verified using a private key of the public-private keypair.

14. The non-transitory machine-readable medium of claim 11, wherein the endpoint device is not in condition to onboard to any orchestrator due to an inability to communicate with a rendezvous server.

15. The non-transitory machine-readable medium of claim 14, wherein the endpoint device lacks the ability to communicate with a rendezvous server due to an operating system failure.

16. An endpoint device, comprising:
a processor; and
a memory coupled to the processor to store instructions, which when executed by the processor, cause operations to be performed, the operations comprising:
in response to the endpoint device powering on:
making, by the endpoint device, a determination regarding whether the endpoint is in condition to onboard to any orchestrator;
in a first instance of the determination where the endpoint device is not in the condition:
broadcasting, by the endpoint device, a challenge to at least one other endpoint device managed by an orchestrator assigned to manage the endpoint device;
obtaining, by the endpoint device, a mutual challenge that is responsive to the challenge;
attempting, by the endpoint device, to verify the mutual challenge;
in a first instance of the attempting where the mutual challenge is verified:
obtaining, the endpoint device, update data from a remote data source using information from the mutual challenge;
using, by the endpoint device, the update data to update operation of the endpoint device to obtain an updated endpoint device; and
onboarding, by the updated endpoint device, to the orchestrator using a first copy of an ownership voucher.

17. The endpoint device of claim 16, wherein the mutual challenge is based on a public key from a second copy of the ownership voucher maintained by the orchestrator, the public key being part of a public-private keypair used by the endpoint device.

18. The endpoint device of claim 17, wherein the mutual challenge is attempted to be verified using a private key of the public-private keypair.

19. The endpoint device of claim 16, wherein the endpoint device is not in condition to onboard to any orchestrator due to an inability to communicate with a rendezvous server.

20. The endpoint device of claim 19, wherein the endpoint device lacks the ability to communicate with a rendezvous server due to an operating system failure.
